(19) United States
(12) Patent Application Publication
(10) Pub. No.: US 2022/0043753 A1
(43) Pub. Date: Feb. 10, 2022

(54) DYNAMIC ALLOCATION OF CACHE RESOURCES

(71) Applicant: Intel Corporation, Santa Clara, CA (US)

(72) Inventors: Elazar COHEN, Haifa (IL); Amir KEREN, Raanana (IL); Iliya BOKHMAN, Be'er Sheva (IL)

(21) Appl. No.: 17/510,955

(22) Filed: Oct. 26, 2021

(51) Int. Cl. G06F 12/0871; G06F 12/0891; G06F 12/0846

(52) U.S. Cl. CPC G06F 12/0871; G06F 2212/7207; G06F 12/0846; G06F 12/0891

(57) ABSTRACT

Examples described herein include a cache controller and a cache device. In some examples, the cache controller is configured, when operational, to: during processor operation, dynamically adjust a maximum number of allocated pinned regions in the cache device based on usage of pinned regions. In some examples, the cache controller is to store an entry into a tag memory based on a number of pinned entries in the cache device not being exceeded. In some examples, the entry includes meta-data information indicative of whether the data is stored in the cache device.

### BACKGROUND

Cache memory is used to reduce the time to access data compared to data access from main memory. In networking applications, lookup tables located in host memory can be stored in a cache for more rapid access. However, cache memory has a limited amount of memory resources. Data in the cache, such as privileged flow entries, can be pinned to prevent eviction of the data from the cache and provide for a timely processing of packet data based the privileged flow entries. Non-pinned data can be evicted from the cache to make room for other data.

Cache eviction schemes include least recently used (LRU) techniques which do not guarantee keeping data in the cache when the data is not accessed recently in time. When a requested data is not stored in the cache, a cache miss occurs, and an access to read the data from main memory can occur. However, accessing the data from main memory can increase data access time and lead to poor cache performance. Some cache solutions can pin a fixed number of entries per cache set to prevent data from being evicted from the cache. Pinning data in a cache can reduce a number of cache misses.

### BRIEF DESCRIPTION OF THE DRAWINGS

FIG. 1 depicts an example system.

FIG. 2 depicts an example system.

FIG. 3 depicts an example process.

FIG. 4 depicts an example process.

FIG. 5 depicts an example of test results.

FIG. 6 depicts an example system.

### DETAILED DESCRIPTION

Data that is accessed from a cached and is to be pinned in the cache can change dynamically according to traffic states (e.g., active or inactive flow). During application run time, some examples determine a ratio between pinned and non-pinned entries in the cache and respond in real-time to changing accesses to data from the cache, and corresponding pinning of data to modify a ratio between pinned and non-pinned entries in the cache. Some examples adjust the number of maximum pinned objects per set adaptive to user needs during application runtime in a range of [0 . . . Number of ways], while the overflow memory can store one or more entries if a number of pinned objects or ways for a set is exceeded. An overflow memory can flexibly store additional numbers of pinned entries than supported by a configuration of number of pinned entries in the cache. If a request is made to store a pinned entry, but there are no unoccupied pinned entries in tag memory, the pinned entry or tag can be stored in overflow memory. In some examples, an overflow memory is not used and instead the tag memory stores pinned entries or tags.

Some examples provide for dynamic modification of a number of pinned ways per set of a cache. Based on monitoring of a level of occupancy of the overflow memory, number of pinned entries per-set can be adaptively modified. This system can dynamically generate a pinning level, increase cache utilization, and address varying pinning requests. The ability to dynamically tune the level of pinning across the cache translates into better utilization of the cache, and saves die area while we try to commit for certain level of pinning.

An entry in a cache can represent an address range or region in memory that stores data that is stored in cache memory. Some examples allow an entry in the cache to be configured as a pinned entry. A field inside a cache entry (e.g., one or multiple bits) can indicate whether a memory region is pinned in the cache.

Pinning entries and corresponding data in a cache can provide predictable data access latency and reduce a number of memory accesses due to cache misses. For example, when a device uses a high priority rarely-used flow context but predictable access to the flow context is needed, the flow context should be retained in cache, even if not recently used.

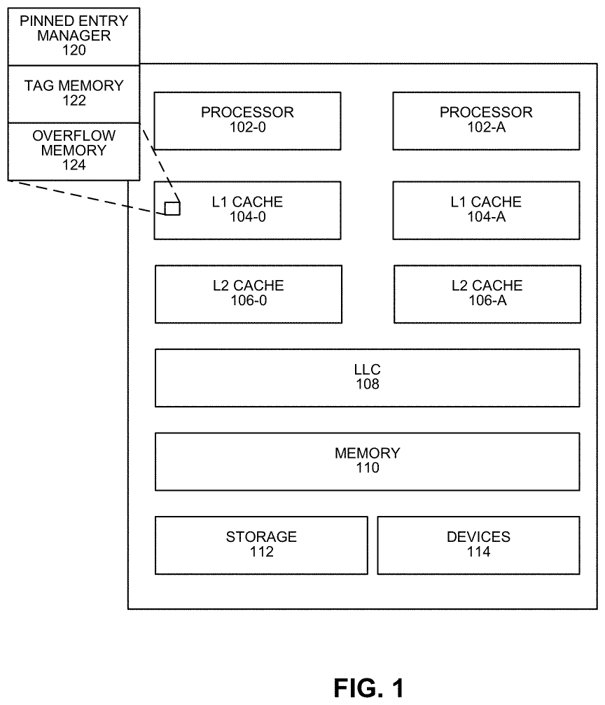

FIG. 1 depicts a system that can manage pinned entries by use of a tag memory and an overflow tag memory. Processors 102-0 to 102-A can include an XPU. An XPU can include one or more of: one core of a central processing unit (CPU), a graphics processing unit (GPU), general purpose GPU (GPGPU), field programmable gate arrays (FPGA), Accelerated Processing Unit (APU), accelerator, or another processor. A core can be an execution core or computational engine that is capable of executing instructions. A core can have access to its own cache and read only memory (ROM), or multiple cores can share a cache or ROM. Cores can be homogeneous and/or heterogeneous devices.

Processors 102-0 to 102-A can access and utilize one or more of Level-1 (L1) cache 104-0 to 104-A, level-2 (L2) cache 106-0 to 106-A, level-3 (L3) cache or Last Level Cache (LLC) 108, volatile or non-volatile memory 110, storage 112, and devices 114. One or more of L1, L2, or LLC can include a pinned entry manager 120 that can manage a number of pinned entries in tag memory 122 and storage of pinned entries into an overflow memory 124, as described herein. One or more of L1, L2, or LLC can include a tag memory 122 can be used to store entries that specify which of the possible memory regions is currently stored in a cache. An entry in tag memory 122 can include one or more of the following fields: entry identifier (ID), address segment, valid indication, pinned indication, least recently used (LRU) indicator. The address segment can include part of an address in main memory of data stored in a cache. One or more of L1, L2, or LLC can include an overflow tag memory that is on-die with the tag memory and that can be used to store entries associated with pinned data write requests where pinned entries are not available in tag memory 122. To set or modify a number of pinned entries in tag memory 122, processors 102-0 to 102-A can execute driver or an on-die firmware engine can manage a number of available pinned entries. Note that although examples are with respect to processors 102-0 to 102-A, other devices described herein (e.g., devices 114) can access one or more of Level-1 (L1) cache 104-0 to 104-A, level-2 (L2) cache 106-0 to 106-A, level-3 (L3) cache or Last Level Cache (LLC) 108, volatile or non-volatile memory 110, or storage 112.

Processors 102-0 to 102-A can execute any application (e.g., virtual machine (VM), container, microservice, serverless application, process, and so forth). The application can request data reads from a memory or writes to a cache. Various examples of the application can perform packet processing based on one or more of Data Plane Development Kit (DPDK), Storage Performance Development Kit (SPDK), OpenDataPlane, Network Function Virtualization (NFV), software-defined networking (SDN), Evolved Packet Core (EPC), or 5G network slicing. Some example implementations of NFV are described in ETSI specifications or Open Source NFV MANO from ETSI's Open Source Mano (OSM) group. A virtual network function (VNF) can include a service chain or sequence of virtualized tasks executed on generic configurable hardware such as firewalls, domain name system (DNS), caching or network address translation (NAT) and can run in VEEs. VNFs can be linked together as a service chain. In some examples, EPC is a 3GPP-specified core architecture at least for Long Term Evolution (LTE) access. 5G network slicing can provide for multiplexing of virtualized and independent logical networks on the same physical network infrastructure. Some applications can perform video processing or media transcoding (e.g., changing the encoding of audio, image or video files).

Data that can be pinned in a cache can include, but is not limited to, data that is lookup from external memory. For example, stored data can include one or more of: MAC context information, IPv4 context information, TCP context information, port/socket context information, or application address information. MAC context information can include information related to a MAC context and can include driver data structures, driver statistic structures, and so forth. For example, IPv4 context information can refer to IPv4 packet processing information such as routing tables, decision to forward, transfer to host, and so forth. For example, TCP context information can refer to information related to a TCP connection and can include one or more of: sequence number, congestion window, outstanding packets, out of order queue information, and so forth. For example, port/socket context information can refer to socket level context information such as but not limited to socket settings, socket flags, address family of socket, queue in network interface device associated with the socket, state of connection (e.g., wait, sleep, activity), threads that are waiting for action, and so forth. For example, application address information can refer to data related to application processing context information.

Devices 114 can include one or more of: an XPU, CPU, CPU socket, graphics processing unit (GPU), processor, network interface device, accelerator device, Board Management Controller (BMC), storage controller, memory controller, display engine, a peripheral device, Intel® Management or Manageability Engine (ME), AMD Platform Security Processor (PSP), ARM core with TrustZone extension, Platform Controller Hub (PCH), application specific integrated circuit (ASIC), and so forth. A network interface device can include one or more of: network interface controller (NIC), network interface card, SmartNIC, router, switch, forwarding element, infrastructure processing unit (IPU), or data processing unit (DPU).

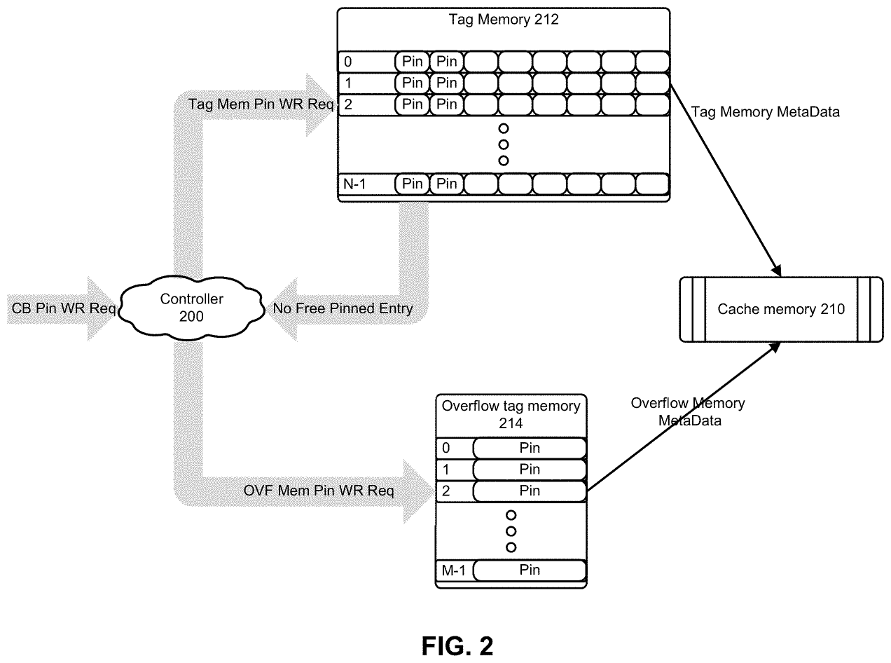

FIG. 2 depicts an example system. The system can be part of a cache bank (CB). Cache memory 2010 can include one or more of: L1 cache, L2 cache, L3 cache, LLC, or a volatile or non-volatile memory. Cache memory 2010 can store data associated with a memory address region or range (not shown) in a local or remote memory device. Tag memory 2012 can identify data that is stored in cache memory 2010 using an entry. In some examples, an entry can include one or more of the following fields: entry identifier (ID), valid indication, pinned/unpinned indication, or least recently used (LRU) indicator.

Tag memory 2012 can store meta-data information (entry) of data stored in cache memory 2010. In this example, tag memory 2012 is configured to store entries for X number of ways for N−1 sets corresponding to data stored in cache memory 2010. Cache memory 2010 can be configured in different schemes. In some examples, cache memory 2010 can be a set-associative cache with 1024 sets with 8 ways, however other numbers of sets and ways can be used. A set-associative cache can be divided into multiple sections called cache ways. A cache way can be treated as a direct mapped cache for a memory location in the main memory. The cache ways can be grouped into sets to create a set-associative scheme, where a set corresponds to a set of main memory locations. For example, a main memory can have 1024 memory locations and can be divided into four sets. A first set of the main memory locations can include locations 0-255, a second set of the main memory locations can include locations 256-511, and so forth. The set-associative cache can have 200 ways that can be grouped into 4 sets of 50 ways, where each set of ways corresponds to a set of main memory locations. For example, a first set of ways can include 50 ways in which data from any of the first set of the main memory locations (memory locations 1-250) can be stored. In another example, a first set of ways can include 50 ways in which data from any of a set of the main memory locations (e.g., memory locations 1, 5, 9, 13 . . . 993, 997) can be stored.

Overflow tag memory 2014 can store meta-data information of data requested to be pinned, but a configured maximum number of pinned entries was previously met. Data corresponding to an entry stored in overflow tag memory 2014 can be stored in cache memory 2010. In some examples, controller 2000 can store an entry into overflow tag memory 2014 based on a permitted number of pinned entries in tag memory 2012 being exceeded. In some examples, overflow tag memory 2014 can be implemented based on a fully associative cache. In some examples, tag memory 2012 and/or overflow tag memory 2014 can be implemented as content addressable memory (CAM) devices. Addressing into overflow tag memory table 2014 can occur using a content addressable memory (CAM). In some examples, overflow tag memory 2014 may not be associated with a set.

In some examples, a cache entry count can be less than memory size. For example, 4 million main memory entries can map into a cache with 8K entries with a ratio of 1:512. In such example, 1K sets and 8 ways can be allocated. Tag memory 2012 can include 1024 sets and 8 ways in each set. Data memory can include 8192 entries and overflow memory 2014 can include 512 entries. Data memory allocated for overflow tag memory 2014 can be in addition to cache data memory. For example, for 1K sets and 8 ways and 512 overflow entries, 8K entries in data memory can be used for the cache (sets * ways) and an additional 512 data entries can be used for overflow memory 2014.

For example, controller 2000 can receive an input at least one or more of: data read request (e.g., non-pinned) from cache that causes data read from memory and write to cache memory 2010; data write to cache memory 2010; write into external memory (not shown) and data flush from to cache memory 2010; or a pinned write request of data to cache memory 2010. For example, pinned write request (cache bank (CB) Pin WR Req) can request a data write to cache memory 2010 and pinning of such data in cache memory 2010 and pinning of an associated entry in tag memory 2012. If tag memory 2012 has not met and not exceeded a number of pinned entries for a set associated with the pinned write request, controller 2000 can cause a pinning of an entry associated with the pinned write request to tag memory 2012 by outputting a pinned write request (Tag Mem Pin WR Req).

However, if tag memory 2012 has met or exceeded a number of pinned entries for a set associated with the pinned write request, controller 2000 can cause a pinning of an entry associated with the pinned write request to overflow tag memory 2014.

Controller 2000 can increase a number of pinned entries in tag memory 2012 based on usage level(s) of overflow tag memory 2014. For example, if a threshold number of pinned entries in tag memory 2012 are used, then a number of pinned entries in tag memory 2012 can be increased. Conversely, if less than a second threshold number of pinned entries in tag memory 2012 are used, where the second threshold number is less than the threshold number, then a number of pinned entries in tag memory 2012 can be decreased. The threshold number can be set to protect against overflow tag memory 2014 being overutilized and unavailable to provide a buffer against excessive requests to pin data in cache memory 2010. Accordingly, dynamic allocation of pinned entries in tag memory 2012 and corresponding memory regions in cache memory 2010 can occur. Controller 2000 can execute firmware code, in some examples.

An example operation of the system of FIG. 2 is described next. In this example, there are 2 pinned entries per set. In response to receipt of a pinned write request with data that is to be pinned (not evictable) in cache memory 2010, the data can be written to cache memory 2010. If there is an available memory region in cache memory 2010, the data can be stored in cache memory 2010 and its corresponding entry stored in tag memory 2012. If there is no available memory region in cache memory 2010, a non-pinned data can be evicted, and the data can be stored in cache memory 2010 as a pinned entry in place of the evicted non-pinned data and its corresponding entry stored in tag memory 2012.

A second pinned write request with second data that is to be pinned in cache memory 2010 is received. If there is an available memory region in cache memory 2010, the second data can be stored in cache memory 2010 and its corresponding entry stored in tag memory 2012. If there is no available memory region in cache memory 2010, a non-pinned data can be evicted, and the second data can be stored in cache memory 2010 as a pinned entry in place of the evicted non-pinned data and its corresponding entry for the second data stored in tag memory 2012.

A third pinned write request with second data that is to be pinned in cache memory 2010 is received. If there is an available memory region in cache memory 2010, the third data can be stored in cache memory 2010 and its corresponding entry stored in tag memory 2012. For example, if the pinning threshold for the set is 2, and 2 pinned items are in the tag memory 2012 for the set, a third pin request item can be stored in overflow memory 2014 even if there is vacant entry in the set.

If there is no available memory region in cache memory 2010, a non-pinned data can be evicted, and the third data can be stored in cache memory 2010 as a pinned entry in place of the evicted non-pinned data and its corresponding entry for the third data stored in tag memory 2012. As two pinned entries are allocated, an entry for the third data can be written to overflow memory 2014.

A client that requests storage of the third data into cache memory 2010 can be informed if the third data is not pinned in cache memory 2010 due to lack of an available memory region such as if there is no evictable data in cache memory 2010. Such feedback may occur if there is no place in tag memory 2012 and the overflow memory 2014 is full.

If a number of pinned entries in overflow tag memory 2014 exceeds a threshold (e.g., 50%), then a number of pinned entries per set can be increased. Multiple thresholds can be set, increases in number of pinned entries per set can rise by meeting different increasing thresholds (e.g., 75%, 90%).

For a received read request for the third data in cache, the third data can be identified as stored in cache memory 2010 and an LRU updated for an entry associated with the third data can be updated. The third data can be provided to the requester.

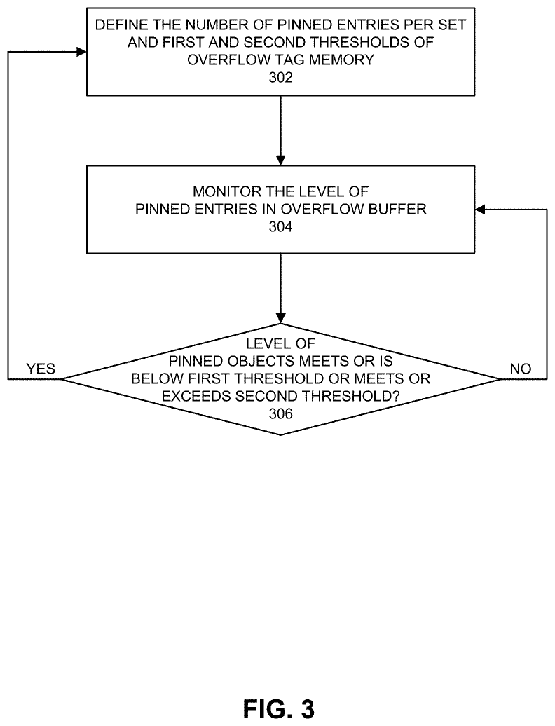

FIG. 3 depicts an example process to allocate a number of pinned entries per set. At 302, a number of pinned entries per set and first and second fill level thresholds of an overflow tag memory can be configured. The number of pinned entries per set can specify a limit of pinned entries in a tag memory. The first fill level threshold can specify a lower fill level of an overflow cache that can trigger a reduction in number of pinned entries per set. The second fill level threshold can specify a higher fill level of an overflow cache that can trigger an increase in number of pinned entries per set. For example, one or more sets of a set-associative cache can be pinned based on the number of pinned entries per set. A number of pinned entries, first, and/or second fill level thresholds could be based on a service level agreement (SLA) in some examples. For example, an orchestrator, driver, on-die firmware engine responsible for cache management, a control plane executed by a server processor, or other examples can perform the configuration.

For example, a MAX_PIN Control and Status Register (CSR) can define the number of pinned entries per set in the range [0 to NumOfWays]. The value in the CSR can change during runtime of an application that utilizes pinned entries, ensuring allocation of pinned objects per set for limited time frame. Parameter OVF_DEPTH can define a size of overflow storage of pinned entries.

At 304, a number of pinned entries in the overflow buffer can be monitored. Receipt of a pinned write request at the CB block can cause the pinned object data to be written to the tag memory. If there is not a free entry in a set for another pinned entry, the entry can be written into the overflow tag memory and the associated data written into cache memory.

At 306, a determination can be made as to whether a number of pinned entries in the overflow tag memory meets or is below the first threshold or meets or exceeds the second threshold. Based on either condition being met, the process can return to 302, where based on the number of pinned entries in the overflow tag memory meeting or being below the first threshold, a number of pinned entries in the tag memory can be reduced; or based on the number of pinned entries in the overflow tag memory meeting or exceeding the second threshold, a number of pinned entries in the tag memory can be increased. In some examples, the first threshold can be 25% occupancy. In some examples, the second threshold can be 50% occupancy. The occupancy level of the overflow tag memory can be limited to provide capability to absorb requests for pinned entries.

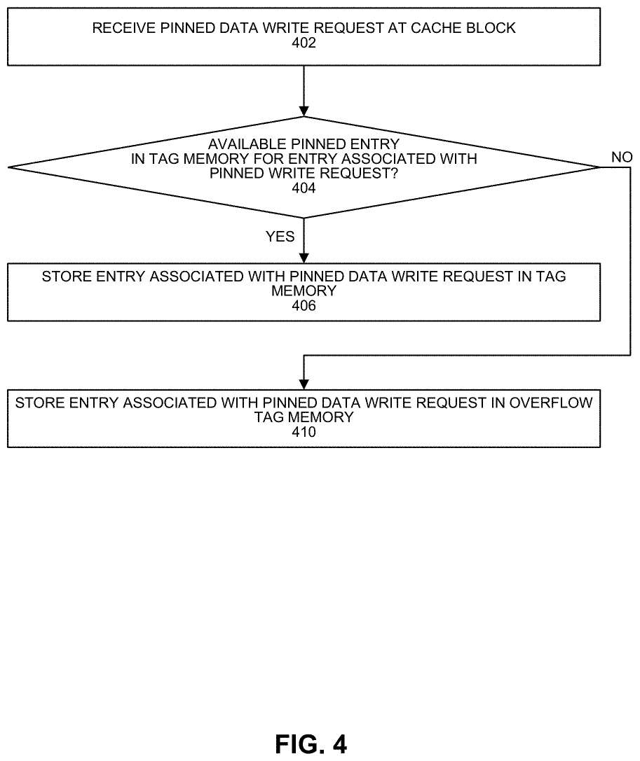

FIG. 4 depicts an example process that can be used to store an entry associated with a pinned write request. At 402, a pinned data write request can be received at a cache block. At 404, a determination can be made if an entry associated with the pinned data write request can be stored in the tag memory of the cache. The number of available pinned entries in the tag memory can be based on a configuration that can be dynamically adjusted. If a pinned entry is available in the tag memory, the process can continue to 406. At 406, the entry associated with the pinned data write request can be stored in the tag memory of the cache.

If a pinned entry is not available in the tag memory, the process can continue to 410. At 410, the entry associated with the pinned data write request can be stored in the overflow tag memory. Note that in some cases, if there is no available pinned region in overflow tag memory, the data and its entry can be stored as unpinned.

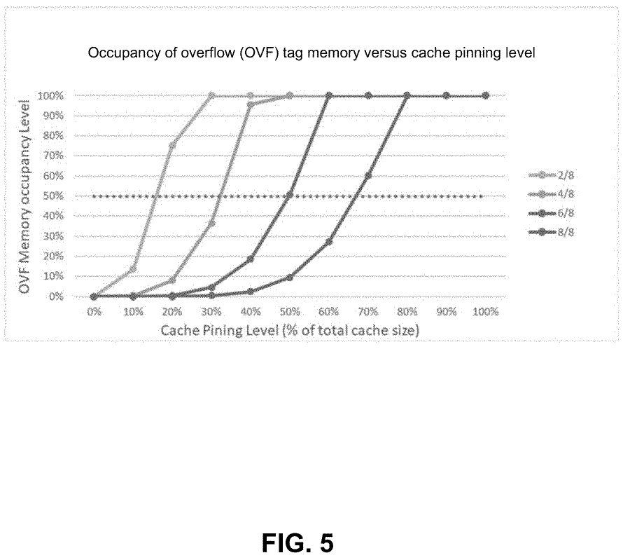

FIG. 5 depicts a number of pinned objects stored in overflow memory per cache pinning level, for different numbers of pinned entries per set. Using dynamic pinning allocation flow allows choice of pinned entries per set to maintain Overflow Memory pinning level below occupancy of 50%. For example, when 30% of the cache is occupied by pinned objects, the number of allocated pinned entries per set can be 4 of 8 to assure Overflow Memory population below 50%.

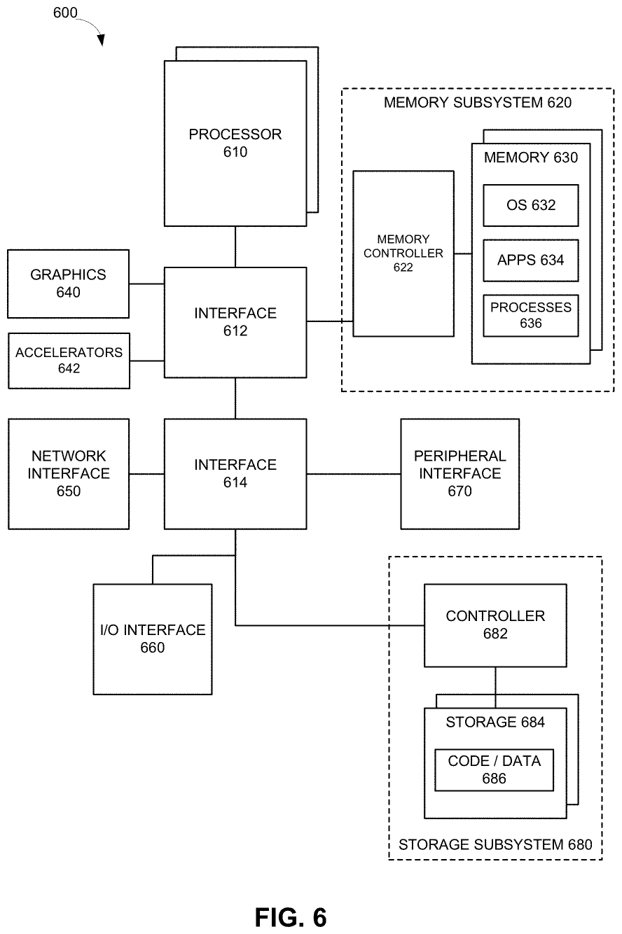

FIG. 6 depicts a system. Various examples can be used by system 600 to adjust a level of pinned entries in a tag memory based on occupancy of an overflow tag memory as described herein. System 600 includes processor 610, which provides processing, operation management, and execution of instructions for system 600. Processor 610 can include any type of microprocessor, central processing unit (CPU), graphics processing unit (GPU), Accelerated Processing Unit (APU), processing core, or other processing hardware to provide processing for system 600, or a combination of processors. Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices. As described herein, microcode of a processor 610 can be updated by an offline-to-online operation and allowing a workload performed by such processor to be executed by another processor.

In one example, system 600 includes interface 612 coupled to processor 610, which can represent a higher speed interface or a high throughput interface for system components that needs higher bandwidth connections, such as memory subsystem 620 or graphics interface 640, or accelerators 642. Interface 612 represents an interface circuit, which can be a standalone component or integrated onto a processor die. Where present, graphics interface 640 interfaces to graphics components for providing a visual display to a user of system 600. In one example, graphics interface 640 can drive a high definition (HD) display that provides an output to a user. High definition can refer to a display having a pixel density of approximately 100 PPI (pixels per inch) or greater and can include formats such as full HD (e.g., 1180p), retina displays, 6K (ultra-high definition or UHD), or others. In one example, the display can include a touchscreen display. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a programmable or fixed function offload engine that can be accessed or used by a processor 610. For example, an accelerator among accelerators 642 can provide sequential and speculative decoding operations in a manner described herein, compression (DC) capability, cryptography services such as public key encryption (PKE), cipher, hash/authentication capabilities, decryption, or other capabilities or services. In some embodiments, in addition or alternatively, an accelerator among accelerators 642 provides field select controller capabilities as described herein. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs).

Accelerators 642 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

In some examples, OS 632 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others. In some examples, a driver can configure a number of pinned entries in tag memory and threshold levels of occupancies of an overflow tag memory that trigger adjustment of number of pinned entries in the tag memory, as described herein.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers or other computing devices) over one or more networks. Network interface 650 can include an Ethernet adapter, wireless interconnection components, cellular network interconnection components, USB (universal serial bus), or other wired or wireless standards-based or proprietary interfaces. Network interface 1050 can transmit data to a device that is in the same data center or rack or a remote device, which can include sending data stored in memory. Network interface 650 can receive data from a remote device, which can include storing received data into memory. As described herein, microcode of a processor 610, memory subsystem 620, network interface 650, or an accelerator 642 can be updated by an offline-to-online operation and allowing a workload performed by such processor to be executed by another processor or accelerator.

In one example, system 600 includes one or more input/output (I/O) interface(s) 660. I/O interface 660 can include one or more interface components through which a user interacts with system 600 (e.g., audio, alphanumeric, tactile/touch, or other interfacing). Peripheral interface 670 can include any hardware interface not specifically mentioned above. Peripherals refer generally to devices that connect dependently to system 600. A dependent connection is one where system 600 provides the software platform or hardware platform or both on which operation executes, and with which a user interacts.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 646 in a persistent state (i.e., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (i.e., the value or state of the data is indeterminate if power is interrupted to system 600). In one example, storage subsystem 680 includes controller 682 to interface with storage 684. In one example controller 682 is a physical part of interface 614 or processor 610 or can include circuits or logic in both processor 610 and interface 614.

A volatile memory is memory whose state (and therefore the data stored in it) is indeterminate if power is interrupted to the device. Dynamic volatile memory can involve refreshing the data stored in the device to maintain state. One example of dynamic volatile memory incudes DRAM (Dynamic Random Access Memory), or some variant such as Synchronous DRAM (SDRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WI02 (Wide Input/output version 2, JESD229-2 originally published by JEDEC in August 2014, HBM (High Bandwidth Memory, JESD325, originally published by JEDEC in October 2013, LPDDR5 (currently in discussion by JEDEC), HBM2 (HBM version 2), currently in discussion by JEDEC, or others or combinations of memory technologies, and technologies based on derivatives or extensions of such specifications.

A non-volatile memory (NVM) device is a memory whose state is determinate even if power is interrupted to the device. In some examples, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

A power source (not depicted) provides power to the components of system 600. More specifically, power source typically interfaces to one or multiple power supplies in system 600 to provide power to the components of system 600. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 600 can be implemented using interconnected compute sleds of processors, memories, storages, network interfaces, and other components. High speed interconnects can be used such as: Ethernet (IEEE 802.3), remote direct memory access (RDMA), InfiniB and, Internet Wide Area RDMA Protocol (iWARP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omnipath, Compute Express Link (CXL), HyperTransport, high-speed fabric, NVLink, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof. Data can be copied or stored to virtualized storage nodes using a protocol such as NVMe over Fabrics (NVMe-oF) or NVMe.

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (i.e., buses) for coupling appropriate integrated circuits (ICs) and other components mounted to the board.

Various examples can be used in a base station that supports communications using wired or wireless protocols (e.g., 3GPP Long Term Evolution (LTE) (4G) or 3GPP 5G), on-premises data centers, off-premises data centers, edge network elements, edge servers and switches, fog network elements, and/or hybrid data centers (e.g., data center that use virtualization, cloud and software-defined networking to deliver application workloads across physical data centers and distributed multi-cloud environments).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (i.e., buses) for coupling appropriate integrated circuits (ICs) and other components mounted to the board.

In some examples, network interface and other examples described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in examples.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative examples. Furthermore, additional operations may be added or removed depending on the particular applications. Any combination of changes can be used and one of ordinary skill in the art with the benefit of this disclosure would understand the many variations, modifications, and alternative examples thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An example of the devices, systems, and methods may include any one or more, and any combination of, the examples described below.

Example 1 includes a computer-readable medium comprising instructions stored thereon, that if executed by one or more processors, cause the one or more processors to: configure a cache device controller to: dynamically, during processor operation, adjust a maximum number of allocated pinned regions in a cache device based on usage of pinned regions.

Example 2 includes one or more examples, wherein the cache device controller is to store an entry into a tag memory based on a number of pinned entries in the cache device not being exceeded and the entry comprises meta-data information indicative of whether the data is stored in the cache device.

Example 3 includes one or more examples, wherein the cache device controller is to store an entry into an overflow memory based on a number of pinned entries in the cache device being exceeded and the entry comprises meta-data information indicative of whether the data is stored in the cache device.

Example 4 includes one or more examples, wherein the usage of pinned regions comprises a number of pinned entries.

Example 5 includes one or more examples, wherein the dynamically, during processor operation, adjust a maximum number of allocated pinned regions in the cache device comprises increase a number of allocated pinned entries based on the usage of pinned regions meeting or exceeding a threshold.

Example 6 includes one or more examples, wherein the dynamically, during processor operation, adjust a maximum number of allocated pinned regions in the cache device comprises decrease a number of allocated pinned entries based on the usage of pinned regions meeting or being less than a second threshold.

Example 7 includes one or more examples, wherein data stored in the cache device comprises one or more of: flow data or connection context.

Example 8 includes one or more examples, wherein a device is to store data to the cache device and the device comprises one or more of: a multi-thread core, a central processing unit (CPU), an XPU, a graphics processing unit (GPU), a network interface device, or application specific integrated circuit (ASIC).

Example 9 includes one or more examples, and includes an apparatus comprising: a cache controller and a cache device, wherein the cache controller is configured, when operational, to: during processor operation, dynamically adjust a maximum number of allocated pinned regions in the cache device based on usage of pinned regions.

Example 10 includes one or more examples, wherein the cache controller is to store an entry into a tag memory based on a number of pinned entries in the cache device not being exceeded and the entry comprises meta-data information indicative of whether the data is stored in the cache device.

Example 11 includes one or more examples, wherein the cache controller is to store an entry into an overflow memory based on a number of pinned entries in the cache device being exceeded and the entry comprises meta-data information indicative of whether the data is stored in the cache device.

Example 12 includes one or more examples, wherein the during processor operation, dynamically adjust a maximum number of allocated pinned regions in the cache device based on usage of pinned regions comprises: increase a number of allocated pinned entries based on the usage of pinned regions meeting or exceeding a threshold or decrease a number of allocated pinned entries based on the usage of pinned regions meeting or being less than a second threshold.

Example 13 includes one or more examples, wherein data stored in the cache device comprises one or more of: flow data or connection context.

Example 14 includes one or more examples, comprising a device to store data in the cache device, wherein the device comprises one or more of: a multi-thread core, a central processing unit (CPU), an XPU, a graphics processing unit (GPU), a network interface device, or application specific integrated circuit (ASIC).

Example 15 includes one or more examples, comprising a data center that includes the device and the cache controller and the cache device, wherein the data center is to execute an orchestrator that is to identify the usage of pinned regions.

Example 16 includes one or more examples, and includes a method comprising: configuring a cache device to: during processor operation, dynamically adjust a maximum number of allocated pinned regions in the cache device based on usage of pinned regions.

Example 17 includes one or more examples, comprising: storing a tag into a tag memory based on a number of pinned entries in the cache device not being exceeded and storing the tag into an overflow memory based on a number of pinned entries in the cache device being exceeded.

Example 18 includes one or more examples, wherein the tag comprises meta-data information indicative of whether the data is stored in the cache device.

Example 19 includes one or more examples, wherein the during processor operation, dynamically adjust a maximum number of allocated pinned regions in the cache device based on usage of pinned regions comprises: increase a number of allocated pinned entries based on the usage of pinned regions meeting or exceeding a threshold or decrease a number of allocated pinned entries based on the usage of pinned regions meeting or being less than a second threshold.

Example 20 includes one or more examples, wherein data stored in the cache device comprises one or more of: flow data or connection context.

What is claimed is:

1. A computer-readable medium comprising instructions stored thereon, that if executed by one or more processors, cause the one or more processors to:
configure a cache device controller to:
dynamically, during processor operation, adjust a maximum number of allocated pinned regions in a cache device based on usage of pinned regions.

2. The computer-readable medium of claim 1, wherein
the cache device controller is to store an entry into a tag memory based on a number of pinned entries in the cache device not being exceeded and
the entry comprises meta-data information indicative of whether the data is stored in the cache device.

3. The computer-readable medium of claim 1, wherein
the cache device controller is to store an entry into an overflow memory based on a number of pinned entries in the cache device being exceeded and
the entry comprises meta-data information indicative of whether the data is stored in the cache device.

4. The computer-readable medium of claim 1, wherein the usage of pinned regions comprises a number of pinned entries.

5. The computer-readable medium of claim 1, wherein the dynamically, during processor operation, adjust a maximum number of allocated pinned regions in the cache device comprises increase a number of allocated pinned entries based on the usage of pinned regions meeting or exceeding a threshold.

6. The computer-readable medium of claim 1, wherein the dynamically, during processor operation, adjust a maximum number of allocated pinned regions in the cache device comprises decrease a number of allocated pinned entries based on the usage of pinned regions meeting or being less than a second threshold.

7. The computer-readable medium of claim 1, wherein data stored in the cache device comprises one or more of: flow data or connection context.

8. The computer-readable medium of claim 1, wherein a device is to store data to the cache device and the device comprises one or more of: a multi-thread core, a central processing unit (CPU), an XPU, a graphics processing unit (GPU), a network interface device, or application specific integrated circuit (ASIC).

9. An apparatus comprising:
a cache controller and
a cache device, wherein the cache controller is configured, when operational, to:
during processor operation, dynamically adjust a maximum number of allocated pinned regions in the cache device based on usage of pinned regions.

10. The apparatus of claim 9, wherein
the cache controller is to store an entry into a tag memory based on a number of pinned entries in the cache device not being exceeded and
the entry comprises meta-data information indicative of whether the data is stored in the cache device.

11. The apparatus of claim 9, wherein
the cache controller is to store an entry into an overflow memory based on a number of pinned entries in the cache device being exceeded and
the entry comprises meta-data information indicative of whether the data is stored in the cache device.

12. The apparatus of claim 9, wherein the during processor operation, dynamically adjust a maximum number of allocated pinned regions in the cache device based on usage of pinned regions comprises:
increase a number of allocated pinned entries based on the usage of pinned regions meeting or exceeding a threshold or
decrease a number of allocated pinned entries based on the usage of pinned regions meeting or being less than a second threshold.

13. The apparatus of claim 9, wherein data stored in the cache device comprises one or more of: flow data or connection context.

14. The apparatus of claim 9, comprising a device to store data in the cache device, wherein the device comprises one or more of: a multi-thread core, a central processing unit (CPU), an XPU, a graphics processing unit (GPU), a network interface device, or application specific integrated circuit (ASIC).

15. The apparatus of claim 14, comprising a data center that includes the device and the cache controller and the cache device, wherein the data center is to execute an orchestrator that is to identify the usage of pinned regions.

16. A method comprising:
configuring a cache device to:
during processor operation, dynamically adjust a maximum number of allocated pinned regions in the cache device based on usage of pinned regions.

17. The method of claim 16, comprising:
storing a tag into a tag memory based on a number of pinned entries in the cache device not being exceeded and
storing the tag into an overflow memory based on a number of pinned entries in the cache device being exceeded.

18. The method of claim 17, wherein the tag comprises meta-data information indicative of whether the data is stored in the cache device.

19. The method of claim 16, wherein the during processor operation, dynamically adjust a maximum number of allocated pinned regions in the cache device based on usage of pinned regions comprises:
increase a number of allocated pinned entries based on the usage of pinned regions meeting or exceeding a threshold or
decrease a number of allocated pinned entries based on the usage of pinned regions meeting or being less than a second threshold.

20. The method of claim 16, wherein data stored in the cache device comprises one or more of: flow data or connection context.
